(19) United States
(12) Patent Application Publication
(10) Pub. No.: US 2008/0121458 A1
(43) Pub. Date: May 29, 2008

(54) Harmonic tone exhaust extension

(76) Inventor: Norris Gregory Sturgis, Nashville, TN (US)

Correspondence Address: Norris G. Sturgis, 2307 Lindell Ave., Nashville, TN, 37204, US

(21) Appl. No.: 11/605,011

(22) Filed: Nov. 29, 2006

(51) Int. Cl. G10K 15/04

(52) U.S. Cl. 181/142

(57) ABSTRACT

What is new with the Harmonic Tone Exhaust Extension is the ability of the manufacturer to make significant changes in the sound (not loudness) of the gases that exit the vehicles' exhaust pipes.

By simply changeing the “slits” in the diaphram in the extension. And it thus becomes possible for the consumer to change the sound of his/her vehicle by unclamping and removing one H.T.E.E. with a diaphram with specific length and size “slits” and clamping on another H.T.E.E. with different length and size slits in the diaphram.

### BACKGROUND

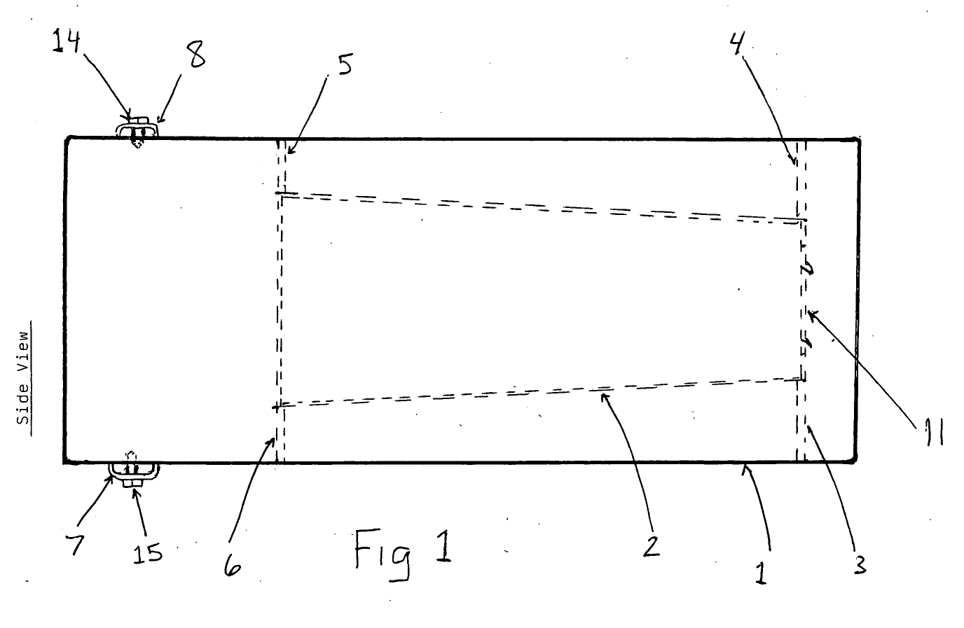

FIG. 1 is a side view of the Harmonic Tone Exhaust Extension (H.T.E.E.) with hidden lines showing its internal design. This view includes the following:

### 1. The steel chrome extension (outside body) can vary in length and diameter.

2. The exhaust funnel directs and compresses some of the exhaust gas to the Harmonic Tone diaphram which is attached to the smaller diameter end. The funnel is steel 3, 4, 5, 6, Mounting brackets which holds the funnel in place. The brackets are made of steel.

### 7, 8. Brackets which holds the screws that secures H.T.E.E. to the vehicle exhaust pipe.

### 11. The diaphram which can be made of tin.

14, 15. screws which secures H.T.E.E. to vehicle exhaust.

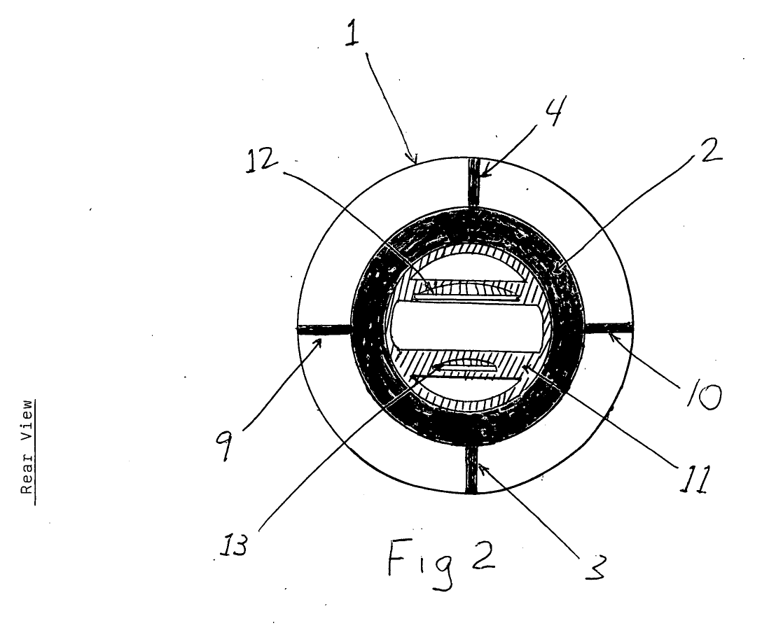

FIG. 2 Rear view of the H.T.E.E.

### 1. See FIG. 1 description 2. See FIG. 2 description

### 3. See FIG. 1 #3 description 4. See FIG. 1 #4 description

### 9. See FIG. 1 #5 description 10. See FIG. 1 #6 description

### 11. See FIG. 1 #11 description 12. Larger slit in diapham

### 13. Smaller slit in diaphram

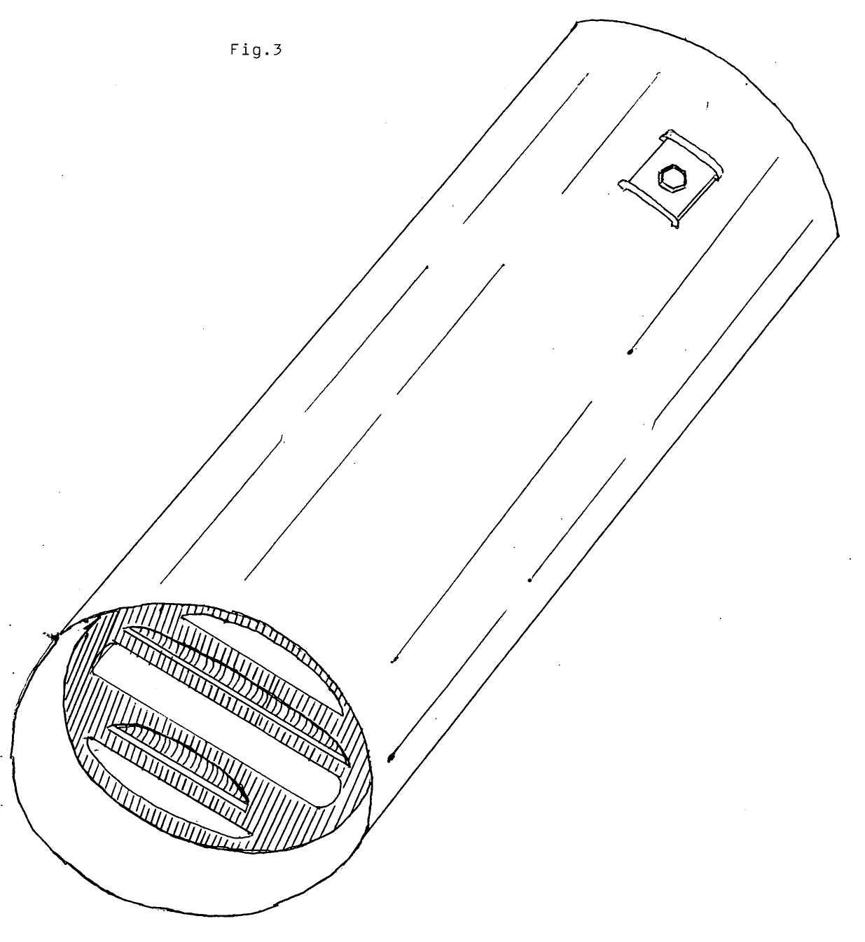

FIG. 3 Three dimensional view of the H.T.E.E.

### OPERATION

The Harmonic Tone Exhaust Extension is a product which uniquely changes the quality of the sound that emits from the exhaust pipe of a motor vehicle. It operates on the same principle as a horn or other “wind” musical instrument. As the exhaust gases push through the diaphram it creates a different tone. Because there are two “slits of different lengths and size, you hear a harmonious tone, much like a hone that emits two different sounds simultaneously.

The Harmonic Tone Exhaust Extension looks very similar to a common chrome, steel extension externally. What makes it uniquely different is a cylindrical tapered funnel with a diaphram on the smaller end.

### The manufacturer can change the length of the “slits” in the diaphram to get the desired harmonic sound.

### SUMMARY

The Harmonic Tone Exhaust Extension utilizes the exhaust gas of the car or truck to make unique sounds similar to a horn or horns.

Depending on how the Harmonic Tone Exhaust Extension is tuned, it could emit sounds that enhances the desireability of the motor vehicle it's installed on.

1. I, Norris Gregory Sturgis claim as my invention the Harmonic Tone Exhaust Extension.
As an integral, internal part of the Harmonic Tone Exhaust Extension is a cylindrical cone (funnel) with a diaphram securely attached at the smaller end.
When the motor vehicle is idleing, accelerating or deaccelerating, the Harmonic tone Exhaust Extension uniquely changes the sound of the exhaust gases exiting the exhaust pipe.
The change in the quality of the sound may increase the marketability of the motor vehicle.
I first conceived the invention on Nov. 10, 2002 and filed it with th USPTO on Oct. 16, 2003.
My Disclosure Document No. is 540169
The Harmonic Tone Exhaust Extension can be sold as an aftermarket product in such places as Auto Parts Stores.
